(19) United States
(12) Patent Application Publication
(10) Pub. No.: US 2008/0239904 A1
(43) Pub. Date: Oct. 2, 2008

(54) METHOD AND APPARATUS FOR INSPECTING A SURFACE OF A SPECIMEN

(76) Inventors: Minoru YOSHIDA, Yokohama (JP); Takayuki Ishiguro, Hadano (JP); Shigeru Serikawa, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/039,758

(22) Filed: Feb. 29, 2008

(30) Foreign Application Priority Data
Mar. 28, 2007 (JP) 2007-084833

(51) Int. Cl. G11B 5/58

(52) U.S. Cl. 369/53.17

(57) ABSTRACT

Inspection with respect to a defect on a surface of a substrate with an inherent or partial wave-like distortion is performed with high accuracy in consideration with the fluctuation caused by the wave-like distortion detected by the defect in excess of the signal level. The substrate is diagonally illuminated while being rotated and moved toward one axial direction to detect the specular reflected light and the scattered light. Based on the detected signal waveform, the state with respect to the inherent or partial wave-like distortion is determined. When the wave-like distortion exists in the substrate, the waveform is divided, and the threshold value is set for the divided regions. The signal higher than the threshold value will be output or displayed as the defect.

### CLAIM OF PRIORITY

The present application claims priority from Japanese Application JP 2007-084833 filed on Mar. 28, 2007, the content of which is hereby incorporated by reference into this application.

### BACKGROUND OF THE INVENTION

The present invention relates to a surface defect inspection method and a surface defect inspection apparatus for optically detecting a defect on a surface of a magnetic disk substrate or a semiconductor wafer, and more particularly, to an inspection technology for reducing the influence of the wave-like distortion of the substrate surface so as to detect, output or display the defect with high sensitivity.

Generally, the magnetically deposited disk substrate has been employed as the magnetic recording medium for the hard disk device. The disk substrate is magnetized by the magnetic head to magnetically record and reproduce the data. Recently, accompanied with improvement in the record density of the hard disk device, the spacing (hereinafter referred to as the flying height) between the recording/writing head (hereinafter referred to as the head) and the disk substrate has been markedly narrowed to be in the range from several tens of nms to several nms.

If a protruding defect which exceeds the flying height exists on the disk substrate, the disk substrate is brought into contact with the head to cause the failure in the hard disk device. In order to improve the yield of the disk substrate, it is important to inspect with respect to the defect as described above before performing the magnetic deposition so as not to feed the defective to the subsequent manufacturing steps. Besides the large defect, a swollen defect (bump defect) or a recess defect (pit defect) may cause the failure. The aforementioned bump defect or pit defect generally has a size of several mms with the height or depth at the gentle inclination ranging from several nms to several tens of nms.

The gentle inclination may be followed by the head so as not to cause the failure owing to the crash, which is regarded as having no problem. However, accompanied with the improvement in the record density, the bump defect or the pit defect may cause such problems as the failure or unevenness of the magnetic deposition. The recording failure has been increasingly caused by the aforementioned defects rather than the physical failure such as the crash of the head. The aforementioned defects are considered to be caused by the defect of the crystal buried in the material of the disk substrate, and the uneven stress resulting from grinding to improve the flatness of the disk substrate.

The foreign substance adhered on the surface may be eliminated or blocked by cleaning the surface repeatedly or cleaning the peripheral atmosphere. Meanwhile, the crystal defect or the flaw such as scratch cannot be recovered, and accordingly, the substrate with such defect will be handled as the defective. In order to make sure to keep the yield and reliability of the hard disk device high, it is critical to eliminate the defective disk substrate as early as possible. The aforementioned defect may occur for some reasons even after the substrate is magnetically deposited. So it is also critical to inspect the surface of the substrate.

It is important to eliminate the defective disk substrate which has been inspected by the surface inspection apparatus. In the apparatus for manufacturing the disk substrate, it is also important to monitor the state of the apparatus, and keep the condition for the purpose of improving the yield.

JP-A-2001-141665 discloses the method in which the substrate surface is diagonally illuminated, and the fluctuation in the light intensity of the reflected light is used for detecting such defect as the bump defect or the pit defect.

JP-A-10-73423 discloses the method for inspecting the substrate with the wave-like deformation. With the method, the detected waveforms are histogram processed to extract the shape of the substrate surface by eliminating the spike noise.

JP-A-5-296939 discloses the apparatus for inspecting the optical disk in consideration with the wave-like distortion of the rotary disk and unevenness in the substrate, in which the light is irradiated to the substrate from the light source, and the light intensity of one of the reflected light, the scattered light, and the interference light from the substrate is detected by the sensor to identify the defect.

JP-A-6-160302 discloses the method for eliminating the influence of the detected wave-like distortion of the detection signal, in which the differential waveforms are repeatedly detected at the same location, the flatness signal is derived from the average value of the waveform, and the detection signal or the threshold value is corrected to eliminate the influence of the wave-like distortion.

In JP-A-2001-141665, when the disk with inherent large wave-like distortion (hereinafter referred to as the disk runout) is inspected, the resultant detection signal also has the large wave-like distortion. The threshold value of the signal level is required to be set to the value equal to or larger than such wave-like distortion, thus having the defect overlooked. With the use of the type for fixing the center in the inspection device to allow both surfaces to be used as the disk for the hard disk device, the deformation which occurs during the fixation may cause the local wave-like distortion around the center. In this case, the detection signal also has the local wave-like distortion, thus having the defect at the point overlooked.

In JP-A-10-73423, the local shape defect of the flat member is inspected through discrimination from the large wave-like deformation. In the aforementioned mode, the range of the histogram processing is changed stepwise to reduce the spike noise so as to suppress the influence of the wave-like distortion on the substrate without considering the local wave-like distortion. The substrate to be inspected has a hole formed in the flat member like a mask member for screen printing. The inspection is performed based on the presence/absence of the hole with no consideration of the foreign substance or flaw on the substrate surface.

JP-A-5-296939 discloses the method for detecting the defect of the optical disk irrespective of gentle or imperceptible unevenness like the warpage and wave-like distortion of the optical disk. In the method, however, the illuminating unit is operated in one-way, and the change in the detected light intensity is obtained by the detector. This may detect the presence/absence of the track and the heterogeneity inside the plastic material like the optical disk. However, the defect with the large area and small height or depth (bump defect or pit defect) cannot be detected.

In JP-A-6-160302, the light is irradiated to the running strip in the width direction to detect the flaw defect on the surface through the reflected light, and the detected light is differentiated. The wave-like distortion is calculated through differentiation, based on which the differential signal or the threshold value is corrected to eliminate the influence of the wave-like distortion. In the method, the detection signal is corrected by processing the wave-like distortion, thus deteriorating the defect detection sensitivity. As the illuminating unit is operated in one-way, the flaw on the surface can be detected. However, likewise JP-A-5-296939, the defect with small height or depth (bump defect or pit defect) cannot be detected.

### SUMMARY OF THE INVENTION

It is an object of the present invention to provide a disk surface defect inspection method and a disk surface defect inspection apparatus capable of performing the process with high accuracy to detect the signal level of the defect by simultaneously detecting the scattered light and the specular reflected light to identify the foreign substance, the flaw, the bump defect and the pit defect, and detecting the specular reflected light to suppress the influence of wave-like distortion on the whole substrate surface or the local wave-like distortion thereon.

That is, it is an object of the present invention to provide the surface defect inspection method and the surface defect inspection apparatus capable of detecting various defects on the substrate surface without being influenced by the wave-like distortion on the substrate surface.

The present invention provides a method for inspecting a defect on a surface of a substrate which includes the steps of irradiating a laser beam diagonally to the substrate which rotates and moves toward an axial direction, detecting scattered light in a first elevation angular direction and scattered light in a second elevation angular direction from the substrate to which the laser beam is irradiated to obtain a first scattered light detection signal and a second scattered light detection signal, detecting specular reflected light from the substrate to which the laser beam is irradiated to obtain a specular reflected light detection signal, and detecting a defect on the substrate by processing the first scattered light detection signal, the second scattered light detection signal and the specular reflected light detection signal. In the step for detecting the defect, the specular reflected light detection signal is processed to obtain information data with respect to a wave-like distortion on the surface of the substrate. A region of the substrate surface is divided based on the information data with respect to the wave-like distortion on the surface of the substrate, and a threshold value is set for determining the defect for each divided region. The first and the second scattered light detection signals are processed to detect the defect on the substrate based on the set threshold value.

The present invention provides an apparatus for inspecting a defect on a surface of a substrate which includes table means on which the substrate is placed to be rotated and moved toward an axial direction, illuminating means for irradiating a laser beam diagonally to the substrate on the table means which is rotated and moved toward the axial direction, first scattered light detection means for detecting light scattered in a first elevation angular direction from the substrate to which the laser beam is irradiated by the illuminating means, second scattered light detection means for detecting light scattered in a second elevation angular direction from the substrate to which the laser beam is irradiated by the illuminating means, specular reflected light detection means for detecting specular reflected light from the substrate to which the laser beam is irradiated by the illuminating means, and signal processing means for processing a detection signal derived from the first scattered light detection means, the second scattered light detection means and the specular reflected light detection means to detect a defect on the substrate. The signal processing means processes a signal detected by the specular reflected light detection means to obtain information data with respect to a wave-like distortion on the surface of the substrate, divides a region on the surface of the substrate based on the obtained information data with respect to the wave-like distortion on the surface of the substrate, sets a threshold value for determining a defect for each divided region, and processes a signal detected by the first and the second scattered light detection means based on the set threshold value to detect the defect on the substrate.

In the present invention, the scattered light and the direct reflected light from the substrate are detected to allow detection of the foreign substance, the flaw, the bump defect and the pit defect on the substrate surface. The fluctuation of the signal waveform is minimized by suppressing the influence of the wave-like distortion over the whole substrate surface or the local wave-like distortion so as to ensure detection of the signal level of the defect. This makes it possible to enable the inspection with high accuracy.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a front view schematically showing a structure of a substrate surface defect detection apparatus according to a first embodiment;

FIG. 2 is a view illustrating an example of a method for manufacturing a disk substrate in the first embodiment;

FIG. 3 is a sectional view showing a defect of the disk substrate in the first embodiment;

FIG. 4 is a top view showing the defect of the disk substrate;

FIG. 5A is a view illustrating generation of the scattered light upon diagonal illumination to the foreign substance on the disk substrate in the first embodiment;

FIG. 5B is a view illustrating the generation of the scattered light shown in FIG. 5A when viewed from the right-angled direction;

FIG. 6A is a view illustrating generation of the scattered light upon diagonal illumination to the scratch on the disk substrate in the first embodiment;

FIG. 6B is a view illustrating the generation of the scattered light shown in FIG. 6A when viewed from the right-angled direction;

FIG. 7 is a view showing generation of the scattered light from the defect of the disk substrate in the first embodiment;

FIG. 8 is a view showing generation of the scattered light from the defect of the disk substrate in the first embodiment;

FIG. 9A shows an example of the method for inspecting the defect with the gentle inclination in the first embodiment, illustrating the state where the reflecting spot light is projected onto the detector and the output of the detector when the disk surface is in the same plane with the baseline;

FIG. 9B shows the state where the reflecting spot light is projected onto the detector and the output of the detector when the disk surface is below the baseline;

FIG. 9C shows the state where the reflecting spot light is projected onto the detector and the output of the detector when the disk surface is above the baseline;

FIG. 10A shows the state where the reflected spot moves up and down as indicated by arrow on the position sensor;

FIG. 10B shows the state where the waveform output from the processing circuit moves up and down as indicated by arrow;

FIG. 11A shows the state where the position of the reflected spot on the CCD sensor 19 changes resulting from the longitudinal movement thereon as indicated by arrow;

FIG. 11B shows the state where the waveform output from the processing circuit laterally changes (along the pixel direction) as indicated by arrow;

FIG. 12 is a top view of the defects on the disk substrate in the first embodiment;

FIG. 13 is a sectional view of the defects on the disk substrate in the first embodiment;

FIGS. 14A and 14B show the scattered light detection signals of the defect on the disk substrate in the first embodiment, wherein FIG. 14A shows the waveform of the scattered light detection signal of the disk substrate surface, which is detected by a detector 8a; and FIG. 14B shows the waveform detected by a detector 8b;

FIG. 15 is a view showing the direct reflected light detection signal of the defect on the disk substrate in the first embodiment;

FIGS. 16A and 16B show a detection signal of the defect of the disk with the wave-like distortion in the first embodiment, wherein FIG. 16A shows a state where the disk substrate having the warpage on the surface owing to the runout is illuminated; and FIG. 16B shows the waveform detected by the detector upon illumination in the state shown in FIG. 16A;

FIG. 17 is a flowchart of a routine for suppressing the wave-like distortion according to the first embodiment;

FIGS. 18A to 18E show the process for suppressing the wave-like distortion according to the first embodiment, wherein FIG. 18A is a top view of the disk substrate illustrating a region 1a around the inside diameter, a region 1b around the center, and a region 1c around the outer periphery; FIG. 18B shows waveforms 508, 509 and 510 obtained at the detected positions of the disk substrate, that is, the region 1a around the inside diameter, the region 1b around the center, and the region 1c around the outer periphery; FIG. 18C shows the waveform derived from the averaging process of the waveforms 508, 509 and 510; FIG. 18D shows the waveform derived from the lowpass filtering to the averaged waveform obtained as shown in FIG. 18C, and FIG. 18E shows the waveform derived from the polynomial calculation to the lowpass filtered waveform as shown in FIG. 18D;

FIG. 19 is a view illustrating the determination with respect to the waveform division according to the first embodiment;

FIG. 20 shows that the waveform is divided into six divisions in the first embodiment;

FIG. 21 shows that the waveform is divided into twelve divisions in the first embodiment;

FIG. 22 shows the threshold values set relative to the waveform divided into six divisions in the first embodiment;

FIG. 23 is a flowchart for determining the defect type in the first embodiment;

FIG. 24 is a flowchart showing the routine for performing the inspection according to the first embodiment;

FIG. 25 is a view showing an example of the monitor screen display according to the first embodiment;

FIG. 26 is a front view showing a structure of a substrate surface defect detection apparatus according to a second embodiment; and

FIG. 27 is a front view showing a structure of a substrate surface defect detection apparatus according to a third embodiment.

### DESCRIPTION OF THE PREFERRED EMBODIMENTS

Embodiments of the present invention will be described referring to the drawings.

### First Embodiment

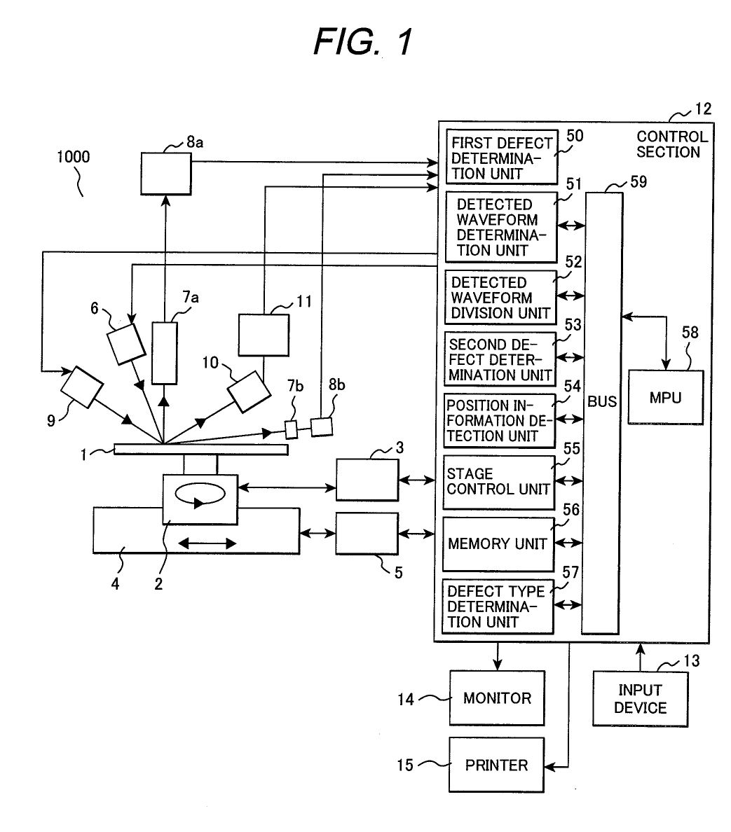

A first embodiment of a defect inspection apparatus according to the present invention will be described referring to FIGS. 1 to 25. FIG. 1 shows a structure of a defect inspection apparatus 1000 according to the embodiment. A disk substrate 1 is fixed to a rotation stage 2 which allows a rotation stage control unit 3 to control the rotating speed, and to detect the position in the rotating direction. The rotation stage 2 may be moved horizontally by a stage 4. The stage 4 allows a linear stage control unit 5 to control the horizontal displacement and to detect the position in the radial direction. A first illuminating device 6 irradiates the laser beam diagonally to the disk substrate 1. A lens 7a is disposed above the irradiated area so as to allow an upper detector 8a to detect the scattered light generated from the disk substrate 1.

A lens 7b and a side detector 8b are allowed to detect the scattered light generated at a low angle out of the detectable range of the upper detector 8a. The photoelectric conversion element, the photomultiplier tube, or the camera may be employed as the detectors 8a and 8b, respectively. The laser beam is irradiated from a second illuminating device 9 diagonally to the disk substrate 1. A detector 10 disposed opposite the laser irradiation direction is allowed to detect the specular reflected light from the disk substrate 1. Likewise the detectors 8a and 8b, the photoelectric conversion element, the photomultiplier tube, or the camera may be employed as the detector 10. The signal from the detector 10 is processed in a calculation circuit 11.

The first illuminating device 6 is positioned at the angle set to the value other than being horizontally positioned (circumferential direction of the disk substrate 1) with respect to the disk substrate 1. In the embodiment, the angle is set to 20° with respect to the perpendicular line. The detector 8b is set at the low angle out of the detectable range of the detector 8a, that is, 80° with respect to the perpendicular line. The second illuminating device 9 is set in the direction other than being horizontally positioned with respect to the perpendicular line and the disk substrate 1 (90° with respect to the perpendicular line), that is, 60° in the embodiment.

The control section 12 includes a first defect determination unit 50 for detecting the defect by processing the detection signals from the detectors 8a and 8b, a detected waveform determination unit 51 for processing the waveform from the calculation circuit 11 which processes the detection signal of the detector 10 to determine the waveform, a detected waveform division unit 52 for dividing the detected waveform based on the result determined by the detected waveform determination unit 51, a second defect detection unit 53 for processing the waveforms divided by the detected waveform division unit 52 to detect the defect, a position information detection unit 54 for obtaining the co-ordinate from the position detected by the rotation stage control unit 3 and the linear stage control unit 5, a stage control unit 55 for controlling the rotation, rotating speed of the linear movement stage, and movement to the detected position, a memory unit 56 which records the results of the first and the second defect determination units 50 and 52, and the results of the position information unit 54 corresponding thereto, a defect type determination unit 57 for determining the defect type based on the results recorded in the memory unit 56, an MPU 58 and a bus 59 for allowing communication and control of the aforementioned units.

An input device 13 is used for inputting the inspection condition such as the threshold value, and the items required for the inspection. A monitor 14 is capable of displaying the detected defect and the screen for assisting the input operation. A printer 15 is capable of outputting the co-ordinate of the defect and the map.

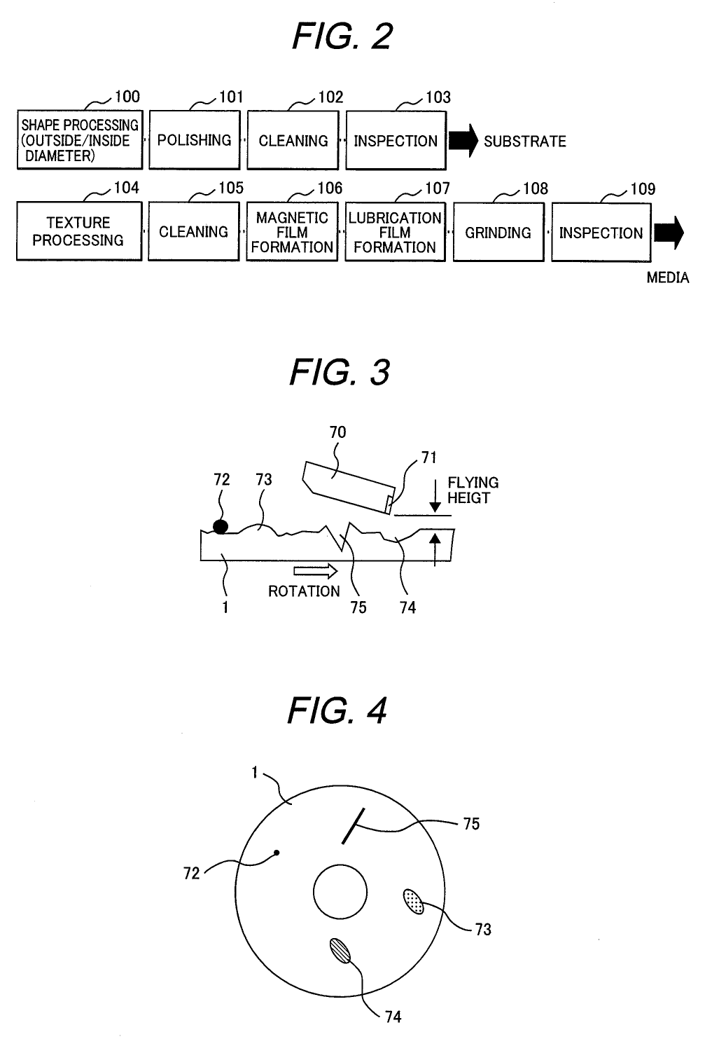

The step for manufacturing the disk substrate for the hard disk device will be described referring to FIG. 2. The step includes the process for producing the substrate before performing the magnetic deposition, and the process for producing the medium coated with the magnetic film. The substrate is formed of the material such as glass or aluminum resin through a shape processing step 100 where the outside diameter and the inside diameter are processed, a polishing step 101 for flattening both sides, a cleaning step 102 for eliminating the adhered foreign substance, and an inspection step 103 for inspecting the state of surface of the thus formed substrate. The medium is formed through a texture processing step 104 for applying a texture onto the surface of the substrate, a cleaning step 105, a magnetic film forming step 106 for depositing the magnetic film by sputtering, a lubrication film forming step 107, a grinding step 108 for grinding to flatten the surface of the medium by polishing or burnishing, and an inspection step 109 for inspecting the state of the surface of the produced medium.

FIG. 3 is a sectional view of the disk substrate illustrating the data recording process in the hard disk device. FIG. 4 shows typical defect types on the disk substrate. Referring to FIG. 3, magnetic reading/writing is performed by a head (magnetic element) 71 formed at the leading end of a magnetic head portion 70 while keeping the disk substrate 1 and the head 71 noncontact. Recently the gap between the disk substrate 1 and the head 71 during the reading/writing so called the flying height or flying height has been narrowed to the value 10 nm or less. The defect on the disk substrate 1 which is smaller than the flying height will not cause the problem. Meanwhile, the defect larger than the flying height may cause the head 71 to be worked off.

FIG. 4 is a top view of the disk substrate. As described referring to FIG. 2, various types of defects may be generated in the manufacturing steps. A foreign substance 72 adheres to the surface of the disk substrate 1 to interfere in the head 71. However, most of the foreign substances may be washed away through the cleaning step before the substrate is installed into the hard disk, which hardly causes the problem. A void defect 73 swollen on the surface of the disk substrate 1, or a pit defect as a recess therein usually occupies a large area (approximately 1 mm) on the disk surface and is thin (ranging approximately from several nms to several tens of nms) as a gentle protrusive- or recess-shaped defect which may be followed by the head 71. However, in the magnetic deposition step, the aforementioned defect is likely to cause the deposition failure as the main cause of the trouble in recording. A scratch 75 is formed through the drop of the abrasive agent in the grinding step for flattening the substrate surface as a long line or short flaw which contains both the protrusive and recess portions. The defect with the sharp protrusion may interfere in the head 71 as the cause of the serious failure. The aforementioned defects are required to be detected in the earlier stage by the inspection apparatus to eliminate the defective. The respective cross sections of the defects are briefly shown in FIG. 3.

The operations of the respective components will be described. In the structure shown in FIG. 1, the first and the second illuminating devices 6 and 9 simultaneously illuminate the surface of the disk substrate 1 on the rotation stage 2. Then the rotation stage 2 with the disk substrate 1 disposed thereon is rotated at the speed controlled by the rotation stage control unit 3. The stage 4 with the horizontal displacement amount controlled by the linear stage control unit 5 is horizontally moved. The stage 4 moves by the amount corresponding to the spot width of the illuminating light for each rotation of the rotation stage 2. The first and the second illuminating devices 6 and 9 diagonally illuminate the surface of the rotating disk substrate 1. When the defect exists on the surface of the disk substrate 1, the reflected light or scattered light will be generated from the defect. The scattered light is partially focused on the objective lens 7a, and detected by the upper detector 8a. The longitudinal fluctuation on the surface of the disk substrate 1 may be detected by the detector 10. The respective signals of the detectors are input to the control section 12 for determining with respect to the defect and the defect type. The determination results will be displayed on the monitor 14.

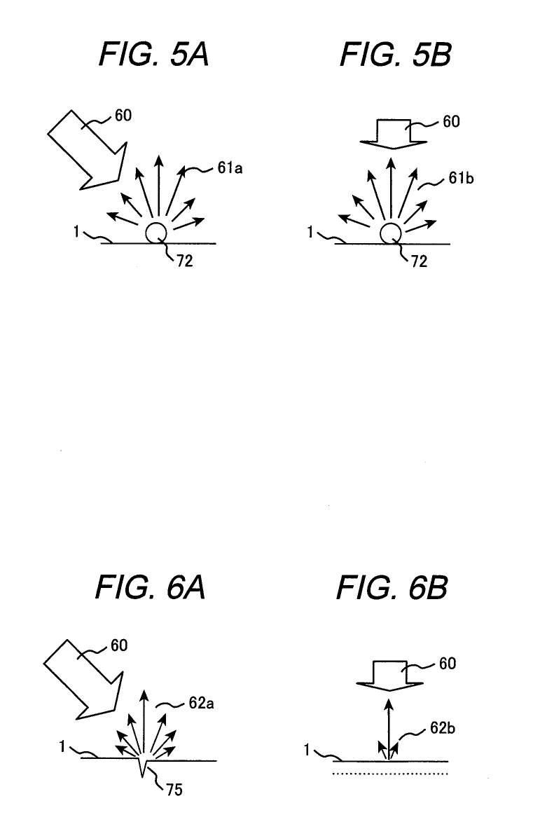

FIGS. 5 to 8 show each example of the scattered light generated from the defect when the substrate is diagonally illuminated. FIGS. 5A and 5B show the protrusive defect such as the foreign substance on the surface of the disk substrate 1. FIG. 5A shows that the substrate is diagonally illuminated from the left side. FIG. 5B shows the state shown in FIG. 5A when viewed from the right-angled direction (opposite the incident direction of illuminating light 60). In response to the diagonal radiation of the illuminating light 60 to the disk substrate 1, the foreign substance 72 generates the scattered light 61a and 61b in the distribution as shown in the drawing. In most of the case, the protrusion such as the foreign substance generates the scattered light which distributes symmetrically in the lateral direction as shown in FIG. 5B. However, the light may distribute asymmetrically in exceptional circumstances depending on the illumination condition and the size of the foreign substance.

FIGS. 6A and 6B illustrate the example where the scattered light is generated from the flaw defect such as the scratch 75. FIG. 6A shows that the substrate is diagonally illuminated from the left side. FIG. 6B shows the illumination state shown in FIG. 6A when viewed from the right-angled direction (opposite the incident direction of the illuminating light 60). In response to the diagonal irradiation of the illuminating light 60 to the disk substrate 1, the scratch 75 generates scattered light 62a and 62b in the distribution as shown in the drawing. The amount of the generated reflected light and the scattered light becomes large in the right-angled direction with respect to the flaw. Meanwhile, the amount of the generated reflected light and the scattered light becomes small along the flaw direction (longitudinal direction; the dotted line shows the bottom of the scratch 75).

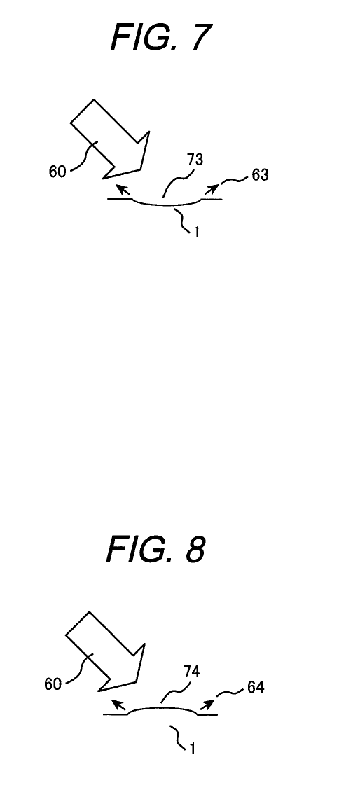

FIGS. 7 and 8 illustrate examples where the scattered light is generated from the pit defect 73 and the void defect 74, respectively. In response to the diagonal irradiation of the illuminating light 60 to the disk substrate 1, the pit defect 73 or the void defect 74 generates small amount of the scattered light 63 or 64, respectively. As each of the defects has a large width and a small depth (height), the inclination of the defect is so gentle that the edge portion hardly generates the scattered light. The defect such as the foreign substance or the scratch may be detected based on the scattered light. Meanwhile, it is difficult to detect the defect with the gentle inclination such as the pit defect or the void defect based on the scattered light.

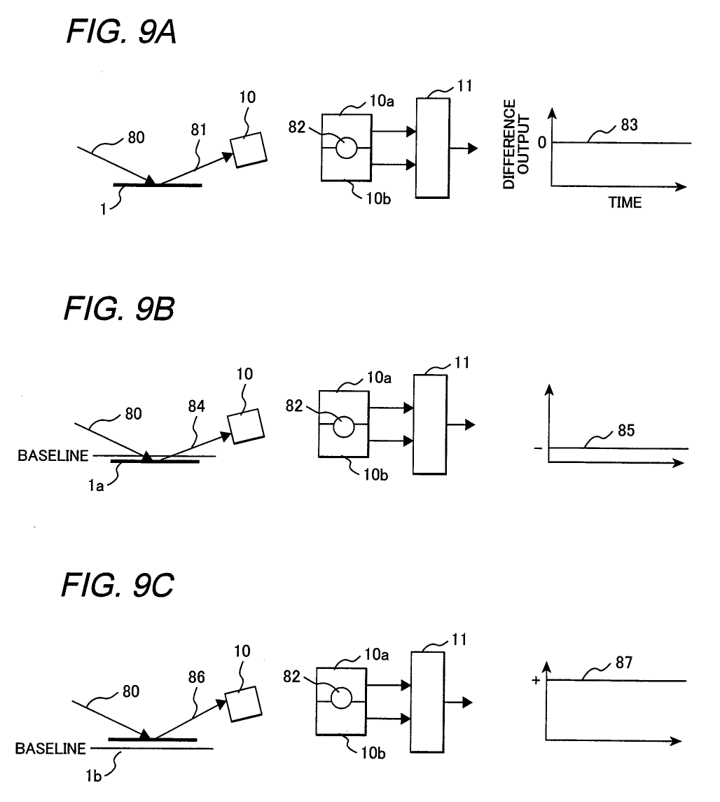

An example of inspection with respect to the pit defect and the void defect will be described. FIGS. 9A to 9C show examples of the inspection with respect to the pit defect and the void defect. Illuminating light 80 is diagonally irradiated to the disk substrate 1. The detector 10 of a dual partitioning type detects specular reflected light 81 from the disk substrate 1. Referring to FIG. 9A, when the disk substrate 1 is in the same plane with the baseline, a reflecting spot 82 on the disk substrate 1 is focused at the midpoint between an upper sensor 10a and a lower sensor 10b of the detector 10. The calculating circuit 11 calculates the difference of the output between the upper sensor 10a and the lower sensor 10b of the detector 10. That is, when the reflecting spot 82 is irradiated to the center of the detector 10, the calculating circuit 11 outputs zero as the difference as indicated by the waveform 83. Referring to FIG. 9B, when the disk substrate 1 is moved below the baseline, the specular reflected light 84 shifts toward the lower sensor 10b, and the waveform 85 shows the output difference changed to the negative side. Referring to FIG. 9C, when the disk substrate 1 is moved above the baseline, the specular reflected light 86 shifts toward the upper sensor 10a, and the waveform 87 shows the output difference changed to the positive side. In reference to the principle, as the disk substrate 1 has the flat surface, the defect with the gentle inclination corresponds to the state where the height of the disk substrate 1 changes. The pit defect and the void defect may be identified by detecting the change in the specular reflected light.

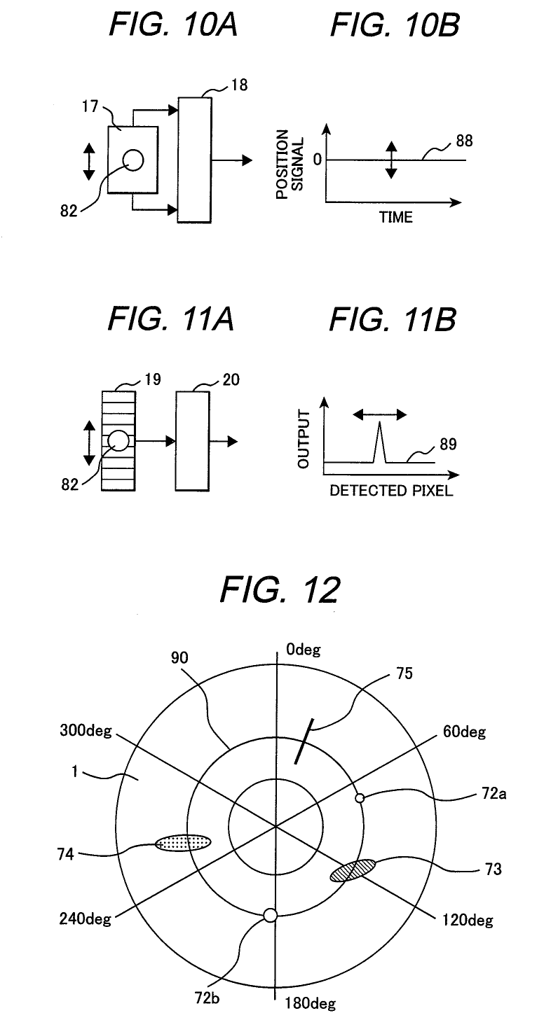

The use of the dual partitioning sensor as the detector 10 has been described referring to FIGS. 9A to 9C. The use of a position sensor 17 may provide the same effect as shown in FIGS. 10A and 10B. Referring to FIG. 10A, when the reflecting spot 82 longitudinally moves as shown by arrow on the position sensor 17, the output balance of the position sensor 17 changes, and the waveform 88 output from a processing circuit 18 also fluctuates longitudinally as shown by arrow in FIG. 10B.

Referring to FIGS. 11A and 11B, the use of a CCD sensor 19 as the detector 10 may also provide the same effect. Referring to FIG. 11A, when the reflecting spot 82 longitudinally moves as shown by arrow to change its position on the CCD sensor 19, the peak position of the waveform 89 output from the processing circuit 20 changes in the lateral direction (along the pixel direction) as shown by arrow in FIG. 11B. The use of the two-dimensional camera instead of the CCD sensor 19 may provide the same effects.

The waveform detected by the surface defect inspection apparatus according to the embodiment will be described. FIG. 12 is a top view of the disk substrate 1. Referring to the drawing, the top portion of the disk corresponds to the angle of 0°, and the bottom portion corresponds to the angle of 180° in a clockwise direction. The angle of 360° takes the same position as that of the angle of 0°. FIG. 12 illustrates the state where the scratch defect (width: approximately 300 nm, depth: approximately 10 nm) 75, a small foreign substance (particle size: approximately 100 nm) 72a, the void defect (swollen portion with width: approximately 1 mm, depth: approximately several nm) 73, a large foreign substance (particle size: approximately 300 nm) 72b, and the pit defect (dent with width: approximately 1 mm, depth: several nm) 74 which are formed on a line 90 at the same distance from the center of the disk substrate 1.

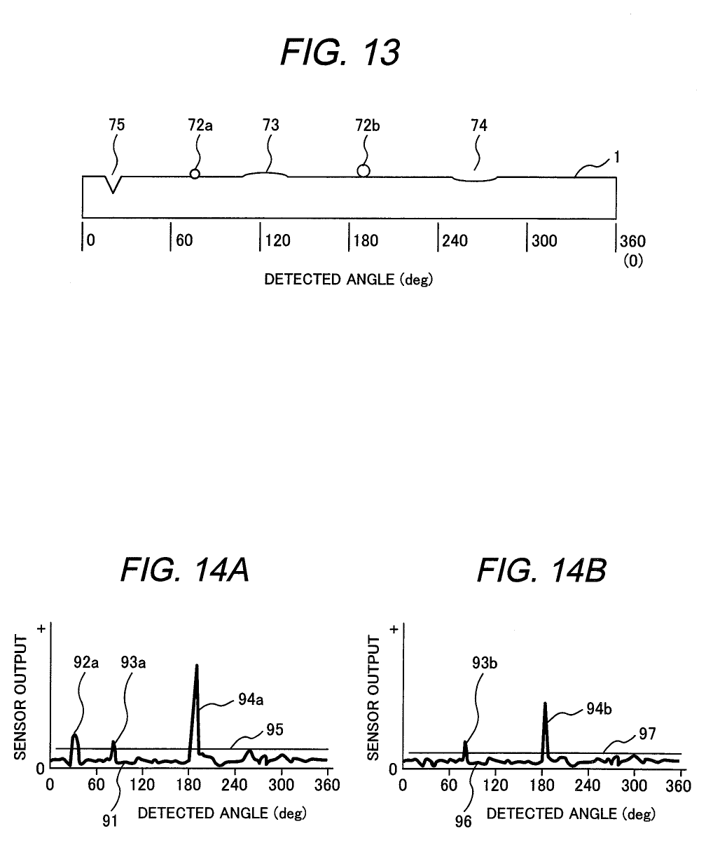

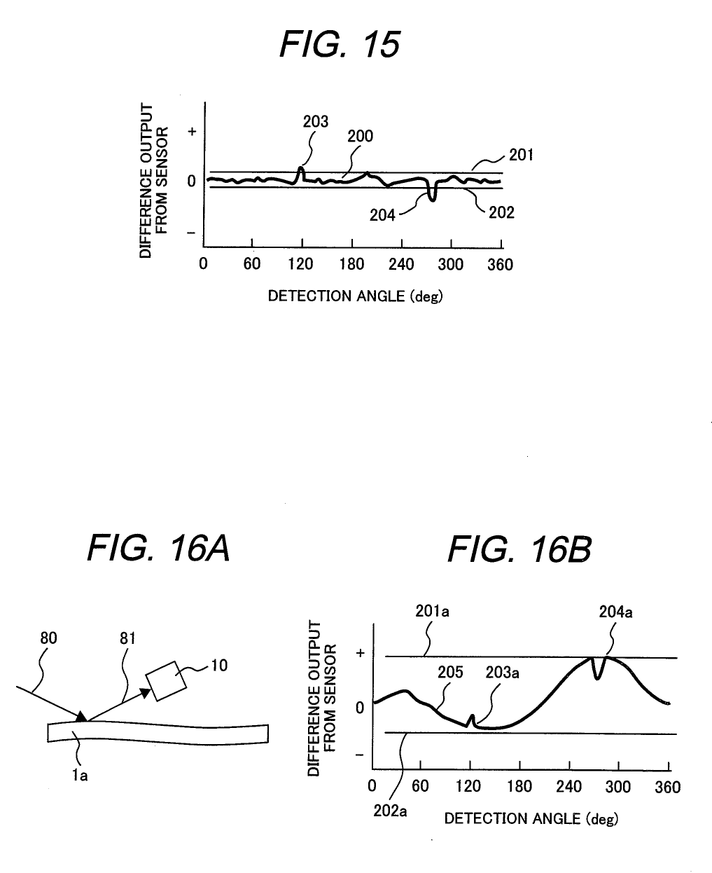

FIG. 13 is a sectional view along the line 90 at the same distance from the center of the disk substrate 1 as shown in FIG. 12. FIGS. 14 and 15 show examples of the detection with respect to the disk substrate 1 having various defects on the line 90 (inspection position). FIGS. 14A and 14B show waveforms of the reflected light (scattered light) from the disk substrate 1, which are detected by the upper detector 8a and the side detector 8b, respectively under the condition where the first illuminating device 6 illuminates the disk substrate 1.

FIG. 14A shows a signal waveform 91 detected by the upper detector 8a, having the x-axis as the detected angle (see FIG. 12) and y-axis as the output of the detector. The signal waveform 91 has peaks which correspond to portions where the respective defects are detected, that is, the peaks 92a, 93a, and 94a correspond to the scratch defect 75, the small foreign substance 72a, and the large foreign substance 72b, respectively. Meanwhile, the peaks corresponding to the void defect 73 and the pit defect 74 shown in FIG. 13 do not appear on the detection signal waveform 91. The control section 12 sets a threshold value 95 relative to the detection signal waveform 91 for detecting the defect.

FIG. 14B shows the signal waveform detected by the side detector 8b. Likewise the case shown in FIG. 14A, the detection signal waveform 96 includes peaks corresponding to the detected defects, that is, the peaks 93b and 94b correspond to the small foreign substance 72a and the large foreign substance 72b, respectively. Meanwhile, the peaks corresponding to the scratch defect 75, the void defect 73 and the pit defect 74 as shown in FIG. 13 do not appear on the detection signal waveform 96. The control section 12 also sets a threshold value 97 relative to the signal waveform for determining the defect likewise the case shown in FIG. 14A.

The scattered light generated from the foreign substance to the upper and the lateral directions may be detected by both the upper detector 8a and the side detector 8b, respectively as described referring to FIGS. 5 to 8. The amount of the upward scattered light generated from the scratch defect 75 is large, but the amount of the laterally scattered light is small. The side detector 8b, thus, is not capable of detecting the scattered light. As the void defect 73 and the pit defect 74 each with no edge and the gentle inclination generates small amount of the scattered light, the output signals from the upper detector 8a and the side detector 8b become small. Accordingly, it is difficult to detect the aforementioned defect based on the output signals from the upper and the side detectors 8a and 8b, respectively.

FIG. 15 shows an example of a signal waveform 200 obtained by detecting specular reflected light from the disk substrate 1 by the detector 10 upon illumination by the second illuminating device 9 to the surface of the disk substrate 1. In this case, the dual partitioning sensor as shown in FIGS. 9A to 9C is employed as the detector 10. The waveform 200 as the calculation result of the output of the detector 10 (dual partitioning sensor) performed by the calculating circuit 11 has the x-axis as the detected angle (see FIG. 12) and the y-axis as the difference output of the calculating circuit 11. The respective output peaks of the signal waveform 200, that is, the signals 203 and 204 correspond to the void defect 73 and the pit defect 74, respectively. However, the peaks of the difference signals corresponding to the foreign substances 72a, 72b and the scratch 75 detected by the upper detector 8a and the side detector 8b do not appear. Threshold values 201 and 202 are set at the positive and negative sides with respect to the difference output relative to the difference signal waveform. When the output value exceeds the threshold values, the substrate is determined as the defect. As the specular reflected light of the void defect 73 or the pit defect 74 with the gentle inclination without edge changes accompanied with the change in the detected position of the reflected light from the disk surface, they may be detected by the detector 10.

Simultaneous detection of the scattered light and the specular reflected light may cover all the defects including the defect like the foreign substance adhered onto the surface, the flaw like the scratch, and the thin defect with the wide area like the void defect and the pit defect.

In the manufacturing process, the warpage in the order of several microns occurs in the actual disk substrate. When the disk substrate 1 is fixed to the inspection apparatus, the warpage may be caused by the stress fluctuation. Accordingly, when the specular reflected light from the disk substrate 1 is detected by the detector 10, the output may fluctuate due to the warpage of the disk substrate 1.

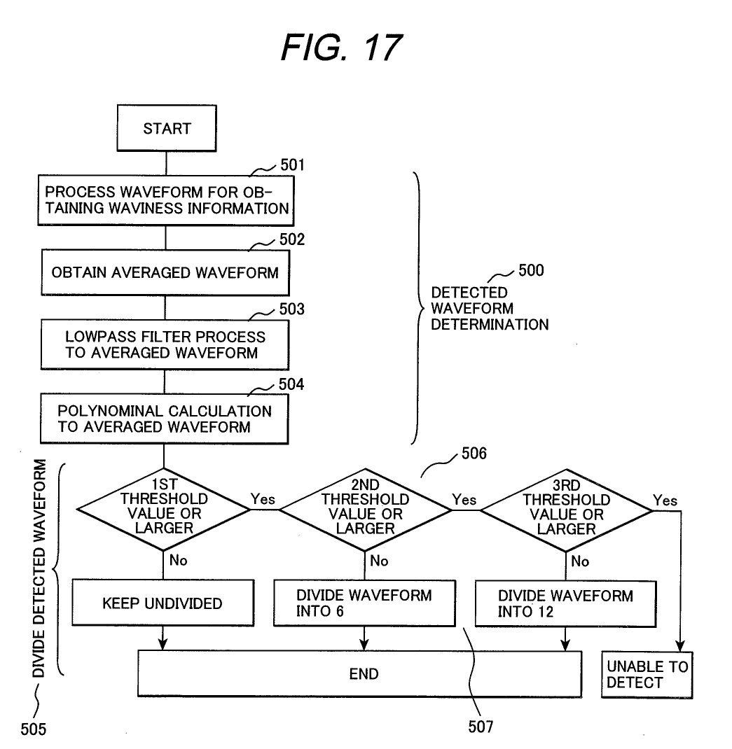

FIGS. 16A and 16B show an example of the aforementioned state. FIG. 16A shows the state where the warpage occurs on the surface of a disk substrate 1a. The disk substrate 1a is illuminated by the illuminating light 80, and specular reflected light 81 from the disk substrate 1a is detected by the detector 10. FIG. 16B shows an output signal waveform 205 output from the calculating circuit 11. The specular reflected light follows the wave-like distortion on the surface of the disk substrate 1a caused by the warpage thereof, and accordingly, the output signal waveform 205 from the calculating circuit 11 also has the sharp wave-like distortion.

The signals 203a and 204a on the output signal waveform 205 corresponding to the void defect 73 and the pit defect 74 are detected. However, threshold values 201a and 202a set outside the detected waveform disables the detection of the aforementioned defects.

The surface defect inspection method and the surface defect inspection apparatus according to the present invention enables the detection of various defects on the surface of the disk substrate 1 without being influenced by the wave-like distortion thereon.

When the surface of the disk substrate 1a with the wave-like distortion is illuminated by the illuminating light 80, the specular reflected light from the surface of the disk substrate 1a is detected to identify the void defect 73 or the pit defect 74 based on the output signal waveform from the calculating circuit 11. FIGS. 17 to 22 show the method for suppressing the influence of the wave-like distortion on the surface of the disk substrate 1a upon the detection of the defects as described above.

FIG. 17 is a flowchart of the routine for suppressing the influence of the wave-like distortion. The routine includes the process 500 for determining the detected waveform, and the process 505 for dividing the detected waveform.

In the process 500 for determining the detected waveform, in step 501 for processing the waveform for obtaining the wave-like distortion information, the detection signal waveform from the detector 10 to be output from the calculating circuit 11 is obtained. Then in step 502, the obtained detected signal waveform is averaged, and in step 503, the averaged signal waveform is lowpass filtered. In step 504, the lowpass filtered signal waveform is subjected to the polynomial calculation to form the signal waveform only with the wave-like distortion information.

In the process 505 for dividing the detected waveform, in step 506, the threshold values are set in several stages relative to the signal waveform with the wave-like distortion information (three values in the embodiment) to determine the number of division or to determine whether the detection is enabled. Then in step 507, the detected waveform is divided in accordance with the determination result.

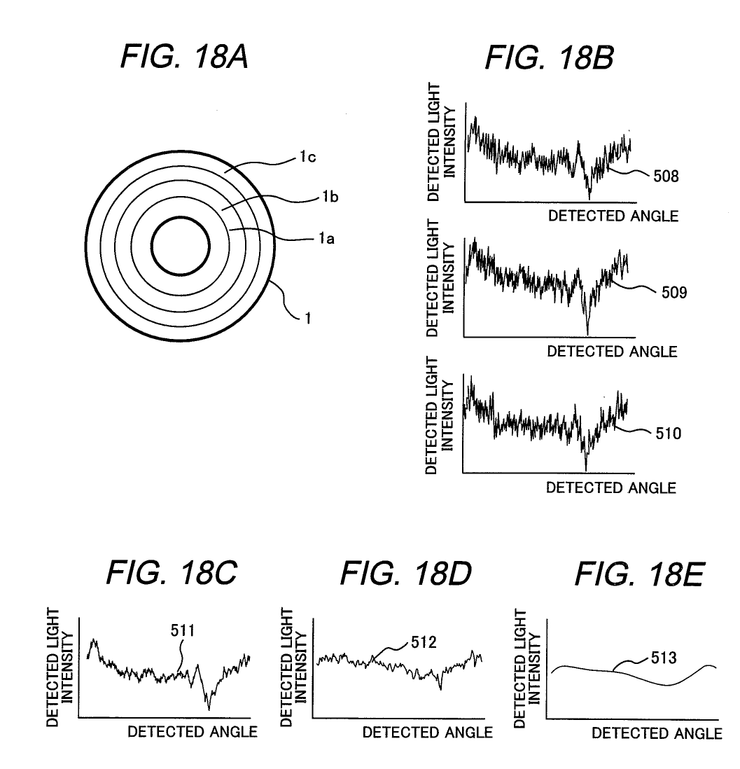

The process for suppressing the influence of the wave-like distortion will be described referring to FIGS. 18 to 22.

FIGS. 18A to 18E show the example of the process 500 for determining the detected waveform. FIG. 18A is a top view of the disk substrate 1 indicating detection positions of an area 1a around the inside diameter, an area 1b around the center, and an area 1c around the outer periphery. FIG. 18B shows waveforms 508 (corresponding to the area 1a around the inside diameter), 509 (corresponding to the area 1b around the center) and 510 (corresponding to the area 1c around the outer periphery) obtained at the respective detection positions in step 501 for processing the waveform to obtain the wave-like distortion information. Referring to FIG. 18B, each x-axis of the graphs denotes the detected angle, and each y-axis denotes the detected light intensity.

In step 502 for averaging process, the average value of the waveforms 508, 509 and 510 is obtained to form the waveform 511 as shown in FIG. 18C. Then the waveform 511 is subjected to the lowpass filter processing in step 503 to form the waveform 512 as shown in FIG. 18D. Then in step 504, the waveform 512 is subjected to the polynomial calculation to form the waveform 513 as shown in FIG. 18E. The resultant waveform shows the state of the wave-like distortion on the disk substrate surface. The lowpass filter process and the polynomial calculating process may be performed in the known procedure. The curve approximation may be used for the polynomial calculation process.

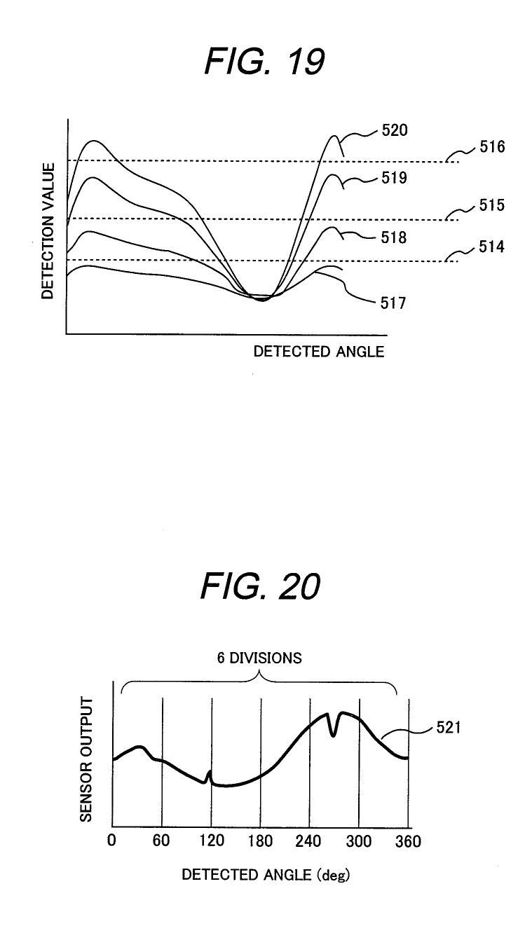

The process 505 for dividing the detected waveform will be described. FIG. 19 is a graph showing step 506 where the threshold values are set with respect to the wave-like distortion. Referring to FIG. 19, three threshold values, that is, a first threshold value 514, a second threshold value 515 and a third threshold value 516 are set in step 506. When the distorted waveform derived in the polynomial calculation step 504 corresponds to a waveform 517, it is determined in the flowchart shown in FIG. 17 that the waveform 517 is kept undivided because it is below the first threshold value 514. When the waveform 518 is below the second threshold value 515, it is determined to be divided into six divisions. When the waveform 519 is below the third threshold value 516, it is determined to be divided into twelve divisions. When the waveform 520 exceeds the third threshold value 516, it is determined that the detection is disabled. The number of divisions is set to six and twelve in the embodiment. However, the user may set any number of divisions.

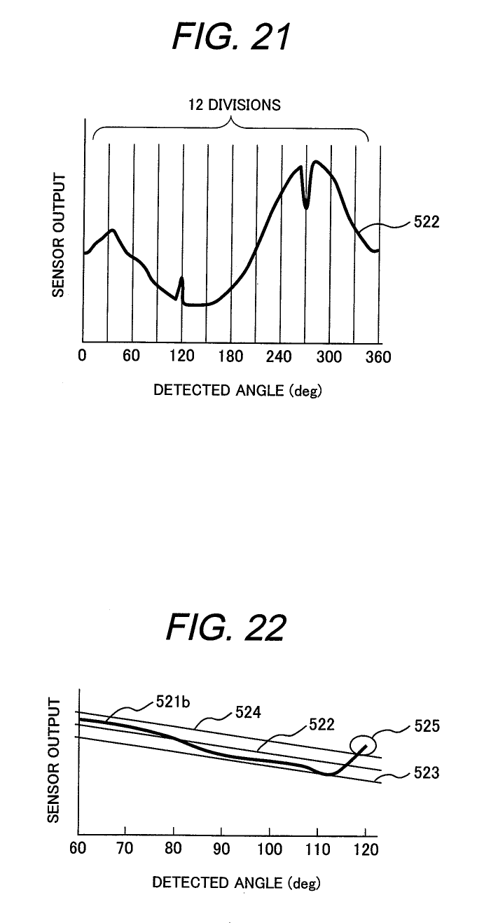

The process 507 for dividing the detected waveform will be described. FIG. 20 shows that the waveform is divided into six divisions, and FIG. 21 shows that the waveform is divided into twelve divisions, each having the x-axis as the detected angle, and the y-axis as the sensor output. The division is performed in the direction of the detected angle. The waveform 521 is divided at every detected angle of 60°, and the waveform 522 is divided at every detected angle of 30°.

FIG. 22 shows a waveform 521b formed by dividing the waveform 521 into six divisions in the range of the detected angle from 60° to 120°. The method for processing the thus divided waveform will be described.

The linear approximate calculation of the waveform 521b is performed to calculate a baseline 522. The linear approximate calculation is performed for each divided waveform to obtain the respective baselines. The predetermined threshold values 523 and 524 (lines formed by plotting the upper limits and the lower limits of the fluctuation of tolerance at the respective detected angular positions of the baseline 522) are set below and above the baseline 522, respectively. The position in excess of the threshold value, that is, the position 525 is determined as being the defect. The aforementioned process is performed with respect to the respective divided waveforms to allow the process using the threshold value while suppressing the influence of the wave-like distortion without setting the threshold value for the entire waveform. The process for dividing the waveform into twelve divisions shown in FIG. 21 may be performed in the same way as the one described above.

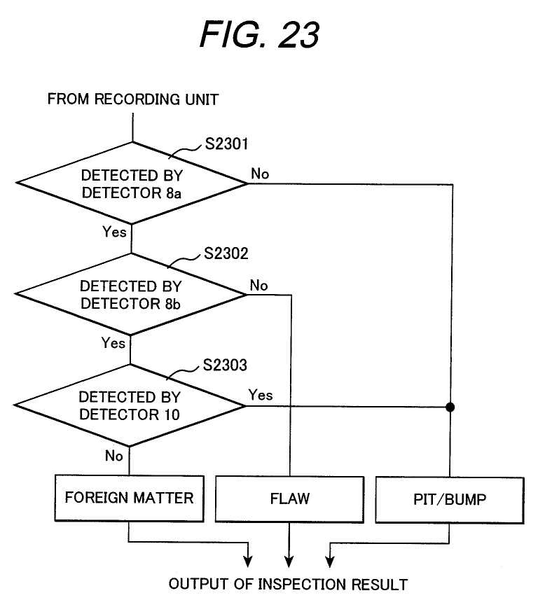

The process for classifying the type of the defect detected by the respective detectors will be described. FIG. 23 is a flowchart of the routine for classifying the defect type. The control section 12 of the inspection apparatus 1000 classifies the defect type based on the signals detected by the detectors 81, 8b and 10, and stored in the memory unit 56. In step S2301, it is determined whether the detection result is obtained by the detector 8a. As described in FIGS. 14A and 14B, the detector 8a detects the scattered light from the defect, and accordingly the defect detected by the detector 8a may be the foreign substance or the flaw. Meanwhile, the pit defect or the bump defect cannot be detected by the detector 8a. Then in step S2302, it is determined whether the detection result is obtained by the detector 8b. As described referring to FIG. 14, the scattered light from the flaw is unlikely to be generated on the periphery. If any one of the defects detected by the detector 8a may further be detected by the detector 8b, the defect is determined as the foreign substance. If the defect which has not been detected by the detector 8b, it is determined as the flaw.

In step S2303, it is determined whether the detection result is obtained by the detector 10. As described referring to FIG. 15, the detector 10 detects the pit defect or the bump defect by detecting the position of the specular reflected light from the disk substrate 1. The output from the detector 10 is calculated in the calculating circuit 11 such that the pit defect and the bump defect may be identified based on the sign of the signal as the calculated result.

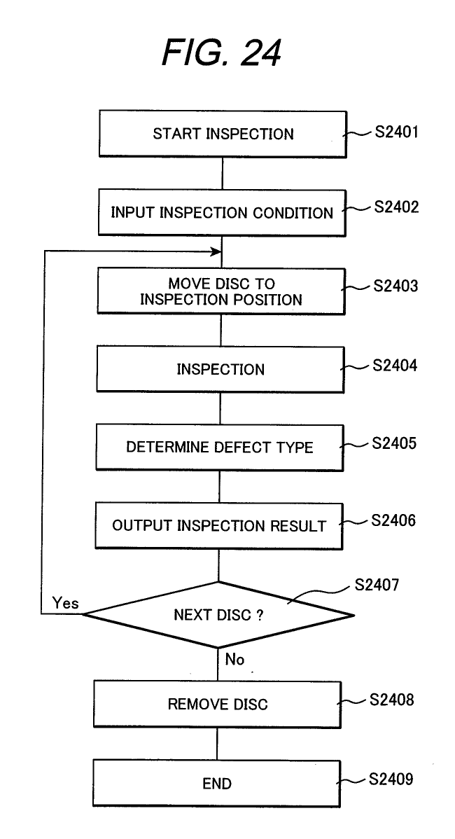

The process for the defect inspection will be described referring to the flowchart shown in FIG. 24. In step S2401, the disk substrate is set in the apparatus to start the inspection. Then in step S2402, the inspection conditions such data as the threshold values and the inspection range are input. In step S2403, the disk is moved to the inspection position to conduct the inspection in step S2404. After conducting the inspection, the defect type is determined in step S2405. Then in step S2406, the inspection result is output when needed. In step S2407, it is determined whether or not the next disk exists. If the next disk exists, the process executes steps from S2403 to S2407 to conduct the inspection repeatedly. When all the disks have been inspected, the disk is removed from the inspection apparatus in step S2408. The inspection then ends in step S2409.

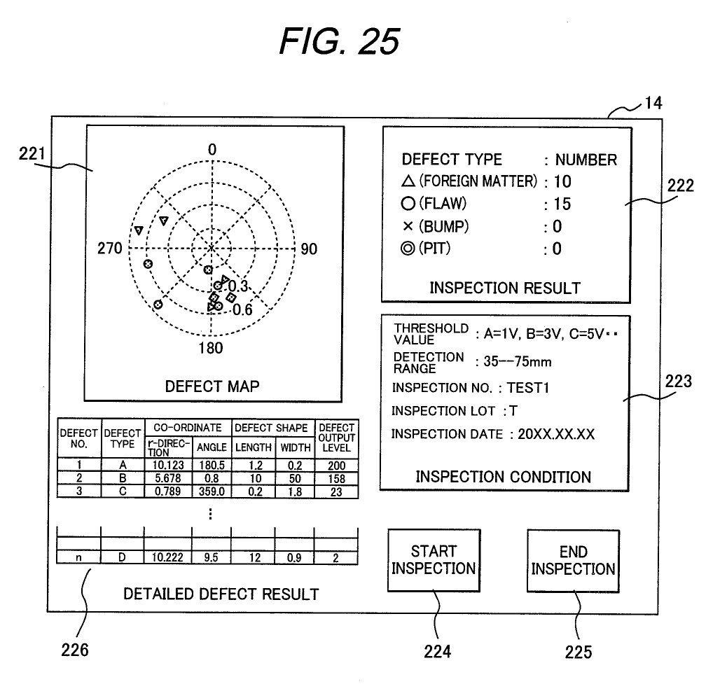

The operation for inputting the inspection conditions will be described. The inspection conditions are input through the input device 13, and the input results are displayed on the monitor 14. FIG. 25 shows an example of the monitor screen display. The screen displays a defect map display section 221 for displaying the top view of the disk, and an inspection result display section 222 for displaying the defect type and the number of the defects. The defect type and the number of the defects may be represented by the corresponding codes so as to be displayed on the defect map 221. The screen further displays an inspection condition display section 223 for displaying results of the input conditions through the input device 13, for example, the threshold value, the inspection range, the inspection lot, the number of disks, and an ON/OFF state of the monitor display, a display section 224 indicating start of the inspection, a display section 225 indicating the end of the inspection, and an inspection result display section 226 for displaying the details including the co-ordinate of the defect detection result, the detection output, and the type of the detector. The aforementioned sections do not have to be displayed on the same screen, but may be partially displayed on the different screen when needed. The partial enlargement, deletion and real-time display with respect to the display sections may be freely set by inputting through the input device 13. The respective data may also be output by the printer 15.

The aforementioned embodiment has been described with respect to the disk substrate used for the hard disk device. However, the same effects may be obtained by use of the semiconductor wafer. Generally, the semiconductor wafer having the flattened surface (for example, bare wafer, and wafer after CMP (Chemical Mechanical Polishing)) to be subjected to the defect inspection may have the thin defect, for example, the foreign substance on the surface, scratch flaw, and water mark generated after cleaning. The wave-like distortion may occasionally occur on the surface of the semiconductor wafer. In the aforementioned case, the influence of the wave-like distortion is eliminated to provide the effect for enabling the defect detection with high accuracy.

The same effect may be obtained by use of the arbitrary article so long as it has the disk-like shape with the possibility to generate the wave-like distortion.

### Second Embodiment

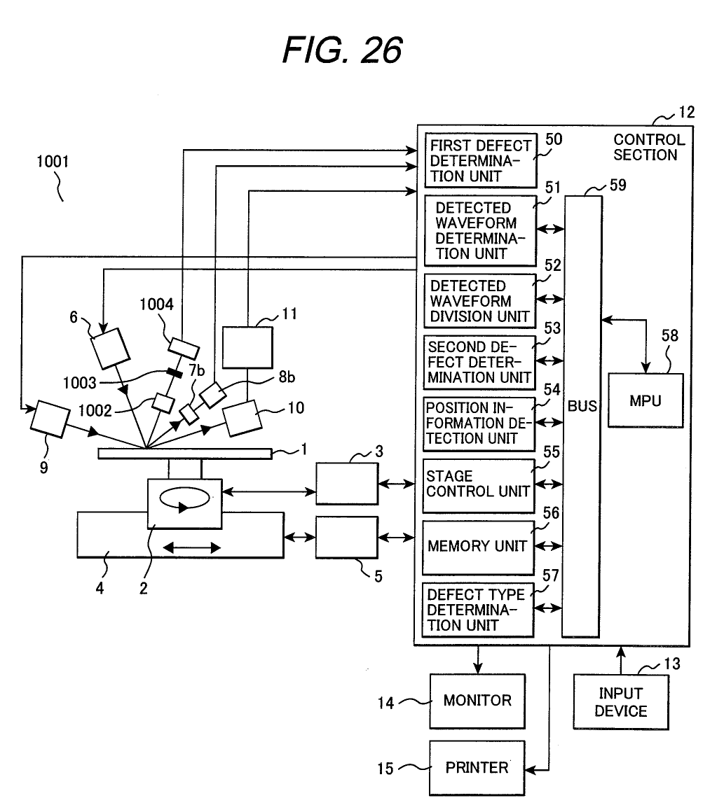

A second embodiment according to the present invention will be described referring to FIG. 26. FIG. 26 shows a structure of a defect inspection apparatus 1001 according to the second embodiment. The same components as those shown in FIG. 1 will have the same functions. The first illuminating device 6 irradiates the laser beam diagonally to the disk substrate 1. A lens 1002 is disposed to face the specular reflected light from the irradiated area. A first detector 1004 detects upwardly scattered light generated from the disk substrate 1. A mask 1003 is disposed to block the specular reflected light other than the scattered light from the disk substrate 1 so as not to allow the specular reflected light from the disk to be projected to the first detector 1004. The other structures and the processing are the same as those described in the first embodiment, thus providing the same effects.

### Third Embodiment

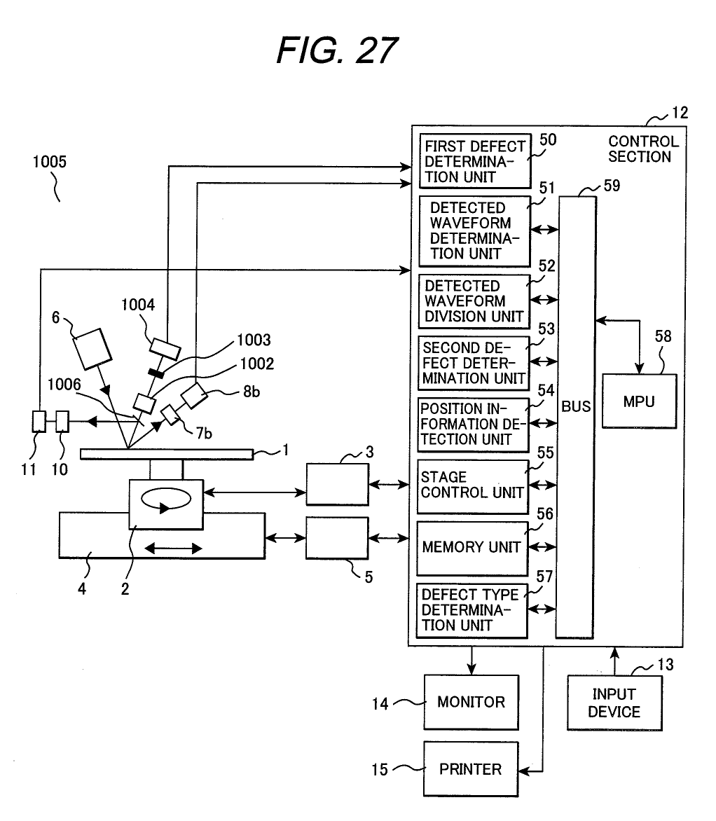

A third embodiment according to the present invention will be described referring to FIG. 27. FIG. 27 shows a structure of a defect inspection apparatus 1005 according to the third embodiment. The same components as those shown in FIG. 1 will have the same functions. The first illuminating device 6 irradiates the laser beam diagonally to the disk substrate 1. A lens 1002 is disposed to face the specular reflected light from the irradiated area. A half mirror 1006 is disposed on the optical path to split the reflected light from the transmitted light. The component of the specular reflected light of the transmitted light is shaded by the mask 1003 so as to allow the first detector 1004 to detect the scattered light from the disk substrate 1. Meanwhile, the specular reflected light from the disk substrate 1 which has been reflected by the half mirror 1006 is detected by the second detector 10.

In the third embodiment, the second illuminating device provided in the first and the second embodiments is not required, thus simplifying the structure. Other structures and processing are the same as those of the first embodiment, thus providing the same effects.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for inspecting a defect on a surface of a substrate comprising the steps of:
irradiating a laser beam diagonally to the substrate which rotates and moves toward an axial direction;
detecting scattered light in a first elevation angular direction and scattered light in a second elevation angular direction from the substrate to which the laser beam is irradiated to obtain a first scattered light detection signal and a second scattered light detection signal;
detecting specular reflected light from the substrate to which the laser beam is irradiated to obtain a specular reflected light detection signal; and
detecting a defect on the substrate by processing the first scattered light detection signal, the second scattered light detection signal and the specular reflected light detection signal,
wherein in the step for detecting the defect, the specular reflected light detection signal is processed to obtain information data with respect to a wave-like distortion on the surface of the substrate;
a region of the substrate surface is divided based on the information data with respect to the wave-like distortion on the surface of the substrate, and a threshold value is set for determining the defect for each divided region; and
the first and the second scattered light detection signals are processed to detect the defect on the substrate based on the set threshold value.

2. The method for inspecting the defect on the surface of the substrate according to claim 1, wherein in the step for irradiating the laser beam, the substrate is illuminated by a first laser beam from a first depression angular direction and a second laser beam from a second depression angular direction.

3. The method for inspecting the defect on the surface of the substrate according to claim 2, wherein the first and the second laser beams simultaneously illuminate the same region on the substrate.

4. The method for inspecting the defect on the surface of the substrate according to claim 2, wherein in the step for obtaining the specular reflected light detection signal, specular reflected light from the substrate, which has been irradiated by the second laser beam from the second depression angular direction, is detected.

5. The method for inspecting the defect on the surface of the substrate according to claim 1, wherein in the step for detecting the defect, the first scattered light detection signal, the second scattered light detection signal and the specular reflected light detection signal are processed to detect the defect on the substrate classified as one of a foreign substance defect, a flaw defect, a pit defect and a bump defect.

6. The method for inspecting the defect on the surface of the substrate according to claim 1, wherein in the step for detecting the defect, a region on the surface of the substrate is divided into a plurality of divisions at equal angles with respect to a center of the substrate based on the obtained information data with respect to the wave-like distortion on the surface of the substrate.

7. An apparatus for inspecting a defect on a surface of a substrate comprising:
table means on which the substrate is placed to be rotated and moved toward an axial direction;
illuminating means for irradiating a laser beam diagonally to the substrate on the table means which is rotated and moved toward the axial direction;
first scattered light detection means for detecting light scattered in a first elevation angular direction from the substrate to which the laser beam is irradiated by the illuminating means;
second scattered light detection means for detecting light scattered in a second elevation angular direction from the substrate to which the laser beam is irradiated by the illuminating means;
specular reflected light detection means for detecting specular reflected light from the substrate to which the laser beam is irradiated by the illuminating means; and
signal processing means for processing a detection signal derived from the first scattered light detection means, the second scattered light detection means and the specular reflected light detection means to detect a defect on the substrate,
wherein the signal processing means processes a signal detected by the specular reflected light detection means to obtain information data with respect to a wave-like distortion on the surface of the substrate, divides a region on the surface of the substrate based on the obtained information data with respect to the wave-like distortion on the surface of the substrate, sets a threshold value for determining a defect for each divided region, and processes a signal detected by the first and the second scattered light detection means based on the set threshold value to detect the defect on the substrate.

8. The apparatus for detecting the defect on the surface of the substrate according to claim 7, wherein the illuminating means includes a first illuminating portion for illuminating the substrate from a first depression angular direction and a second illuminating portion for illuminating the substrate from a second depression angular direction.

9. The apparatus for detecting the defect on the surface of the substrate according to claim 8, wherein the first and the second illuminating portions are structured to illuminate the same region on the substrate simultaneously.

10. The apparatus for detecting the defect on the surface of the substrate according to claim 8, wherein the specular reflected light detection means detects specular reflected light from the substrate illuminated by the second illuminating portion.

11. The apparatus for detecting the defect on the surface of the substrate according to claim 7, wherein the signal processing means processes a signal detected by the first and the second scattered light detection means and the specular reflected light detection means to detect the defect on the substrate classified as one of a foreign substance defect, a flaw defect, a pit defect and a bump defect.

12. The apparatus for detecting the defect on the surface of the substrate according to claim 7, wherein the signal processing means divides the region on the surface of the substrate into a plurality of divisions at equal angles with respect to a center of the substrate based on the obtained information data with respect to the wave-like distortion on the surface of the substrate.

13. The apparatus for detecting the defect on the surface of the substrate according to claim 7, further comprising:
an input device for inputting a condition including a threshold value, an inspection range, an inspection lot, the number of the substrates, and an ON/OFF state of a monitor display; and
a monitor for displaying an inspection result including an inspection condition, a co-ordinate of a defect detection result, and a detection output.

14. The apparatus for detecting the defect on the surface of the substrate according to claim 7, wherein the substrate is formed as one of a disk substrate for a hard disk device and a semiconductor wafer.
